(19) United States
(12) Patent Application Publication
(10) Pub. No.: US 2004/0213382 A1
(43) Pub. Date: Oct. 28, 2004

(54) Methods and positioning and aiming assemblies for use with an x-ray source

(75) Inventors: Henri Andell, Espoo (FI); Lauri Nordlund, Helsinki (FI)

Correspondence Address: STEINBERG & RASKIN, P.C., 1140 AVENUE OF THE AMERICAS, 15th FLOOR, NEW YORK, NY, 10036-5803, US

(73) Assignee: Planmeca Oy

(21) Appl. No.: 10/767,602

(22) Filed: Jan. 28, 2004

Related U.S. Application Data
(60) Provisional application No. 60/443,228, filed on Jan. 28, 2003.

(51) Int. Cl. H05G 1/02

(52) U.S. Cl. 378/197

(57) ABSTRACT

The present invention relates to directing an x-ray beam to image data receiver attached to a holder, especially to such systems used in dental x-ray imaging. In prior art it is known to use an assembly including a sensor holder and an aiming arm attached together, to be attached to the x-ray source in order to aim and orientate the x-ray beam correctly to the sensor. Such systems have proven to be difficult to use in practice, however, because of e.g. the troubles involved in keeping the sensor in place inside the patient's mouth while making the connection between the aiming arm and the x-ray device. The invention provides an enhancement by providing an aiming arm with a handle, which may be used for not only helping handling the thin aiming arm but also in positioning, aiming and orientating the x-ray beam. Preferably such a handle includes a contact construction, which create at least two contact points, at least one contact line and/or at least one contact surface when brought in contact with its counter surface, counter element or the like on the x-ray tube.

### FIELD OF THE INVENTION

The present invention relates to directing an x-ray beam to image data receiving means attached to a holder, especially to such systems used in dental x-ray imaging. The invention provides advanced possibilities for placing an x-ray tube to a correct position and preferably also aligning the x-ray beam with respect to the position and orientation of the image data receiving means positioned in the mouth, for receiving image data of a desired object region of dental arc.

### BACKGROUND OF THE INVENTION

Dental intra oral radiographs are taken by using x-ray examination devices typically including a multi-jointed arm assembly and an x-ray source, e.g. an x-ray tube, situated in a housing connected to the arm assembly. Typically an elongated collimator for defining a beam is attached or made attachable to the housing. The imaging process includes positioning the x-ray device proximate to the object region to be imaged and aligning the x-ray beam such that it will hit the sensor in correct orientation and at a desired angle. Typically the beam will be directed perpendicular to the film—or some other sensor positioned inside the mouth.

The problems involved in aiming and orientating the beam co-centric, not inclined nor turned with respect to the image data receiving means in order to avoid geometric distortions and lack of sharpness in the image, are widely recognized by the dental professionals. Thus, in order to facilitate correct positioning of the x-ray source with respect to the sensor, various aiming systems have been developed. One prior art approach is to physically connect the x-ray source and the image data receiving means, such as film, phosphorus imaging plate, charge coupled device or other digital sensor, for the duration of the exposure.

In intra oral imaging only a certain one or a certain few teeth are typically imaged, and the image data receiving means will thus have to be positioned at various different positions inside the mouth. Therefore, regardless of the detector technology used, the sensor itself is designed as generally flat or in a plate-like configuration and with standardized dimensions so that it may be placed into the oral cavity, fitted to a standardized size holder. Of the numerous existing holders many are designed to be connectable, at least primarily, with sensors of certain types—in practice often with sensors of a certain manufacturer. Some of the known holder constructions include a bite block, which is to be gently bitten between the teeth in order to aid in keeping the sensor in its proper place and orientation.

Should one wish to be certain that the sensor and the x-ray source are positioned with respect to each other in a desired manner, a system that physically and non-movably connects them to each other obviously solves all the positioning and orientating problems from the technical point of view. Connection assemblies designed according to such an approach typically include an aiming arm which is connectable to both the sensor holder/bite block and the x-ray source housing. The latter connection is typically made via an aiming ring attached to the collimator tube of the x-ray source housing. As in intra oral imaging a number of imaging modes exist, including e.g. left and right side anterior, posterior, endodontic and bitewing imaging, in order to be able to support the various sensor positions and alignments with respect to the x-ray beam, the assemblies will have to include parts of specific shapes for these specific imaging modes. Some prior art systems and assemblies utilizing this approach are presented in patent publications U.S. Pat. No. 6,343,875 B1, U.S. Pat. No. 5,632,779 A, U.S. Pat. No. 4,507,798 A and U.S. Pat. No. 4,554,676 A.

Many dental professionals find systems in which the sensor positioned inside the mouth is physically fixed to the x-ray source difficult to use in practice, however. That is because if, for the first, all the connections of the system are made prior to positioning the sensor in the mouth, it has proven to be difficult to maneuver the entire system, including the relatively heavy x-ray tube and its arm assembly, to a proper and precisely correct position. On the other hand, if the sensor is positioned first into its correct position in the mouth, it has proven difficult to put the assembly together, i.e. to connect e.g. the aiming arm to the x-ray source, so that the sensor does not move as a consequence of the connecting process and without causing discomfort to the patient.

Because of these practical difficulties in the above mentioned operations, the technical advantages of these systems are often ignored and aiming is done by simply visually estimating the correct position and orientation of the x-ray source, possibly with the aid of the position and orientation of an aiming arm sticking out from patient's mouth. There has also been attempts to use the thin aiming arm by manually placing it in contact with the outer surface of e.g. the collimator of the x-ray tube in order to facilitate aiming. This has met with only limited success, however, not the least because it has proven to be quite difficult to simultaneously keep the sensor in a correct position by handling the thin aiming arm between one's fingers and at the same time to maneuver the x-ray source arm assembly, especially into contact with the thin aiming arm. The odds of managing to repeatedly accomplish the same distance between the x-ray source and the sensor, not to mention proper and precise orientating of the beam, by such procedures are obviously not too high.

A further problem of the prior art assemblies is that because a great number of different parts are required in order to be able support all the various intra oral imaging modes, substantial experience or “trial and error-learning” is needed in order to be able to put correctly and quickly assemble the system for each imaging mode.

A need exists, therefore, for a positioning and aiming system that would be easier to use yet support all the typical intra oral imaging modes while providing and would provide if not perfect, accurate and repeatable positioning, aiming and orientating. A further advantage would be if such a system would be easy to assemble correctly for the imaging mode in question, when so desired by creating at least a non-fixed connection of the holder and aiming arm assembly to the x-ray source housing.

### SUMMARY OF THE INVENTION

It is an object of the invention to provide a new dental x-ray sensor and x-ray tube positioning system.

It is a further object of the invention to provide a new dental x-ray sensor and x-ray tube aiming and orientating system.

It is yet another object of the invention to provide a positioning and aiming assembly including at least one handle having means by which it is attachable to and therefore releasable from an aiming arm of the positioning and aiming assembly.

It is yet another object of the invention to provide such an assembly including one or more handles, which provides at least two contact points, at least one contact line and/or at least one contact surface attached to it with the surface of the x-ray source housing or any accessory, such as an elongated tubular collimator.

It is yet another object of the invention to provide an aiming assembly including means for guiding the user in putting the assembly together properly, especially in view of proper horizontal/vertical orientation of the sensor.

It is a further object of the invention to provide a handle with sensor orientation markings that guide a dental professional to correctly assemble the parts of the aiming assembly.

It is yet another object of the invention to provide an assembly which includes at least one fixed position of the handle on the aiming arm, or a scale or other indicia on the aiming arm and/or on the x-ray tube housing or any part attached to it, which will aid in repeatedly obtaining a constant distance between the radiation source and the image data receiving means for individual exposures.

These and other objects of the present invention, as well as the advantages thereof over the prior art will become apparent in the following description and are accomplished by means hereinafter described and claimed.

Preferred forms of the subject aiming assembly are shown by way of example in the accompanying drawings, and are deemed sufficient to effect a full disclosure of the invention. The exemplary assembly is described in detail without attempting to show all of the various forms and modifications in which the invention might be embodied, as the characteristic features of the invention are defined in the claims that follow.

### BRIEF DESCRIPTION OF THE DRAWINGS

FIG. 1 shows a typical intra oral x-ray apparatus;

FIG. 2a shows a typical imaging position of a jointed arm construction used in intra oral x-ray apparatus;

FIG. 2b shows an x-ray tube housing of an intra oral x-ray apparatus and an attachable collimator used therein;

FIGS. 3a and 3b show a handle comprising a component of a positioning and aiming assembly according to a preferred embodiment of the invention, the handle being connectable to an aiming arm—bite-block—sensor holder assembly;

FIG. 4 shows a preferred use of two handles according to FIG. 3a, when aiming the beam is wished to be accomplished without fixedly connecting the handle as fixed to the x-ray tube housing;

FIG. 5 shows a handle attached to an aiming ring

FIG. 6 shows an embodiment of a positioning and aiming assembly according to the invention.

### DETAILED DESCRIPTION OF THE INVENTION

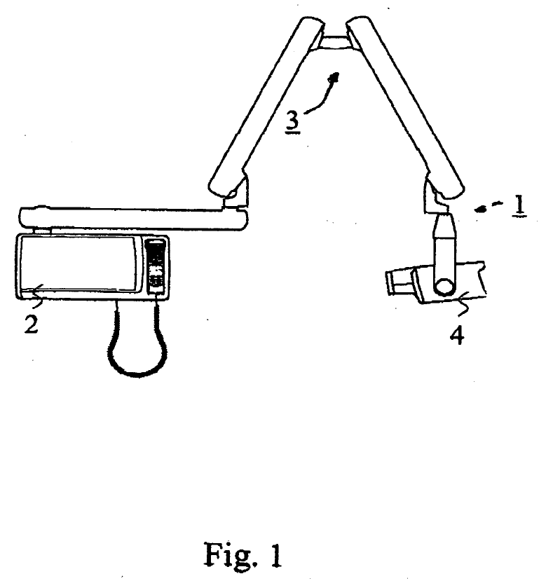

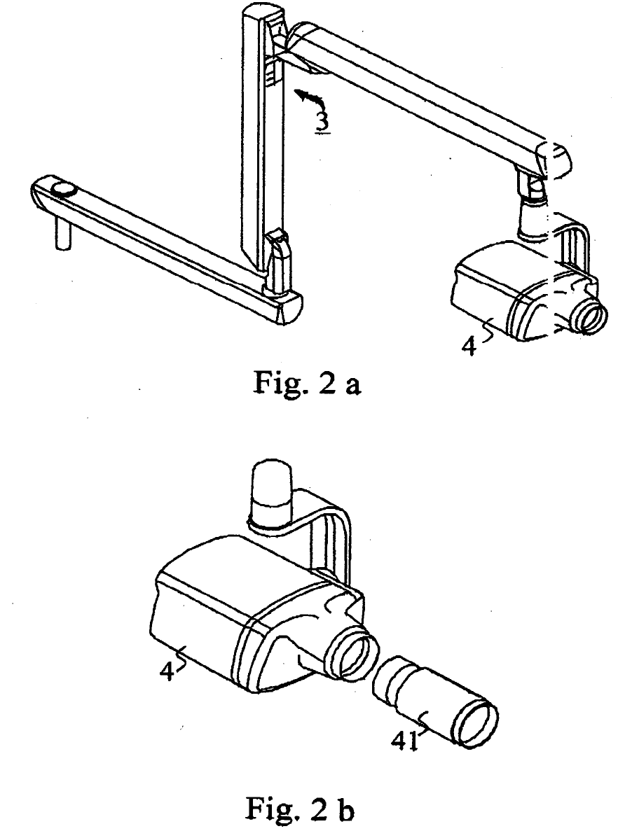

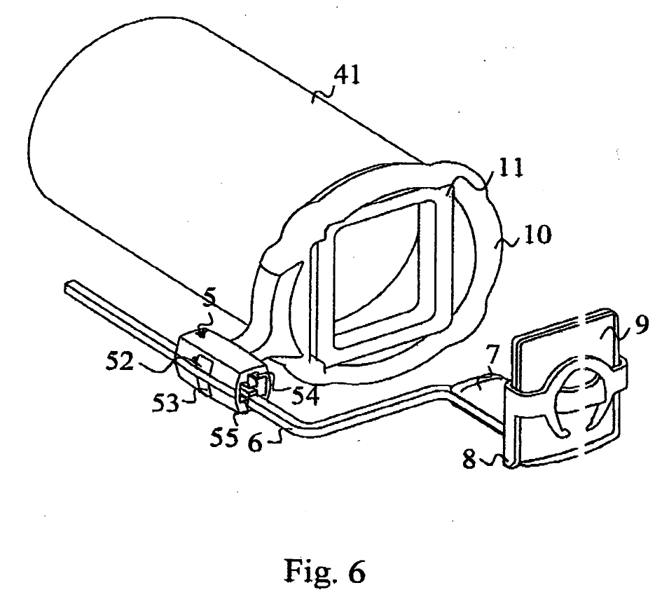

FIGS. 1, 2a and 2b show a typical intra oral x-ray apparatus 1, including a control panel 2, a jointed arm assembly 3 and an x-ray source housing 4. In FIG. 2b there is additionally shown an elongated collimator 41, which can be attached to the x-ray source housing 4 for limiting the beam in order to minimize the radiation dose to be received by a patient. To the same end it is also known to use an additional rectangular collimation plate 11, shown in FIG. 6, attached to the end of the collimator 41. The complex arm assemblies 3 of intra oral x-ray devices provide many degrees of freedom to position the x-ray source in a desired manner, but on the other hand it is a mechanical challenge to be able to tune such assemblies so that the x-ray tube is at the same time light and easy to maneuver yet stable after the desired position is found.

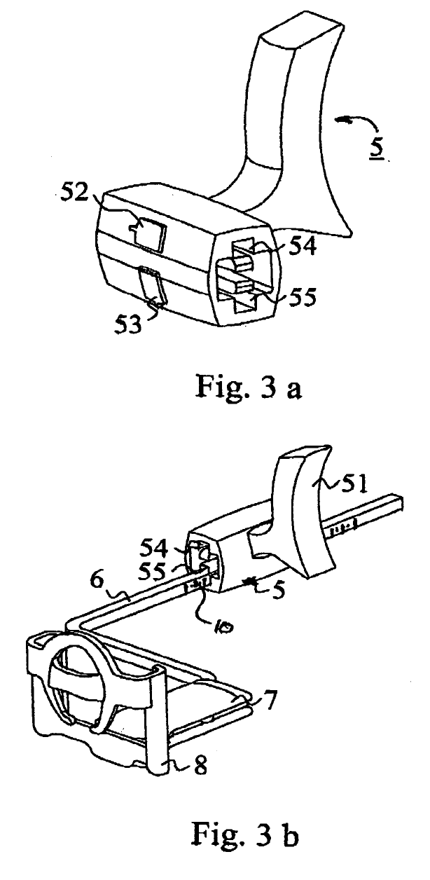

FIGS. 3a and 3b show an embodiment of a outreach element of the invention: a handle 5 according to a current preferred embodiment, which includes means 54, 55 by which it is connectable to and therefore releasable from an aiming arm 6—bite-block 7—sensor holder 8 assembly. Preferably the construction of the handle 5, or the handle assembly as a whole, is such that it creates more than one contact point, or at lest one contact line and/or at least one contact surface 51, with the x-ray source housing 4 or any part, such as the collimator 41, being attached thereto. According to the design of the embodiment shown in the Figs, the contact surface 51 of the handle 5, which is designed to come into contact with the outer surface of the collimator 41, is of the same curvature as that of the collimator surface so that when one positions the elongated contact surface 51 of the handle 5 perpendicular to the longitudinal axis of the tubular collimator 41, at least a mating, releasable, non-turnable, i,e, rotatably freed, connection is created between the handle 5 and the collimator 41. This allows for, in combination with the aid of the enhanced handling of the aiming arm 6 via the handle 5, a simple and easy-to-use positioning and orientating of the x-ray tube with respect to the position and orientation of a sensor placed inside the mouth. Instead of an actual contact surface 51, one or more contact lines or more than one contact points may be arranged on the handle 5. Especially when a construction including three suitably arranged contact point is used, an effective aid for positioning, aiming and orienting the x-ray tube with respect to sensor position and orientation will be achieved when assembled to the aiming arm.

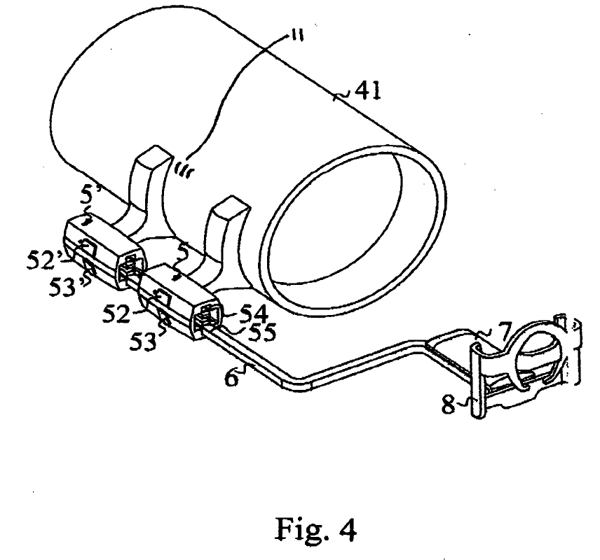

In the embodiment according to the Figs., the means 54, 55 for connecting the handle 5 to the aiming arm 6 constitute properly designed apertures for the aiming arm 6, which makes it possible to adjust the position of the handle 5 with respect to the sensor holder 8 by sliding the handle 5 along the aiming arm 6. There may be arranged in the aiming arm 6 a scale 10 (FIG. 3b) or one or more fixed or releasable positions for the handle 5, and additionally corresponding markings 11 (FIG. 4) on the x-ray source housing 4 or any accessory, such as a collimator 41, attached thereto, too, for ensuring that a desired x-ray source—image data receiving means—distance may be repeatedly reached. A handle 5 attachable to the aiming arm 6 may be made of use even if no special contact surface 51 or equivalent means for aiding aiming and orientating of the x-ray tube are present, as it then still serves as a gripping part and thus aids in handling the aiming arm 6. This is especially the case when fixed or adjustable (not fixed) reference positions for the handle 5 are used, which as described above may be used for helping repeatedly achieve a desired x-ray beam focal spot—sensor—distance by visually utilizing a reference point or a reference structure arranged on the x-ray source housing or any part attached to it, or by bringing such point or structure of the x-ray source housing or any part attached to it into contact with the handle.

Obviously, when this kind of an assembly is used in intra oral imaging, various kinds of bite-blocks 7 for different imaging modes will have to be used—or in case the assembly does not include bite-blocks 7, holders 8 and/or aiming arms 6 of various shapes would have to be used. The parts of the assembly may be designed in a way that one and the same construction may be used both in left and right side imaging of a patient. The bite-block 7 presented in the Figs. of the present specification is intended for anterior/posterior imaging. In addition to the sensor holder 8 shown in the Figures, which is designed for vertical orientation of the sensor, a different holder for horizontal positioning may be designed. In view of the invention it does not make difference if the connections between the parts attached to the aiming arm 6 will be made detachable or not.

FIG. 4 shows such a preferred use of an aiming assembly according to the invention, where handles 5 according to FIG. 3a are used without making a fixed connection between them and the x-ray tube housing 4. According to this embodiment, there are attached to the aiming arm 6 two handles 5, 5′, whose contact surfaces 51 have the same curvature as does the outer surface of the collimator 41. The invention thus enables a dental professional to first assemble the desired sensor holder 8—bite-block 7—aiming arm 6-assembly including two handles 5, then place the sensor attached to its holder 8 in the desired position in the patient's mouth and finally simply align the collimator 41 by bringing it into mating contact with both of the contact surfaces 51 of the handles 5, 5′. Obviously even just one handle 5 could be used, but using two makes aligning the beam more accurate.

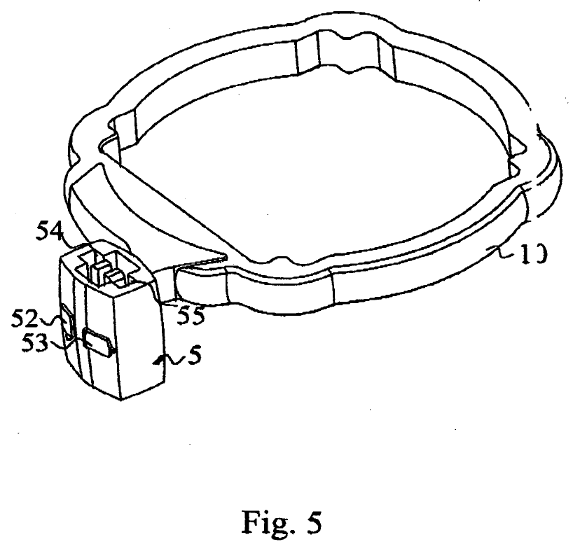

FIGS. 5 and 6 show a handle 5 as attached to an aiming ring 10, which may be attached e.g. to the end of an elongated collimator 41. In FIG. 6 a digital sensor 9 is fixed to the sensor holder 8, as well as a further collimator blade 11 for limiting the beam according to the shape and dimensions of the sensor 9 used. The collimator blade 11 may alternatively serve as an adapter for attaching the aiming ring 10 to the end of the collimator 41. This embodiment of the invention secures correct orientation of the x-ray tube. Dental professionals may be encouraged to use even the full benefits of a fixed positioning and aiming assembly according to the invention despite the known problems involved in making fixed connections after the sensor 9 has been positioned inside the mouth, especially if an appropriately easy-to-make connection construction between the handle 5 and e.g. the aiming ring 10 is used, since the handle 5 will make handling the aiming arm 6 easier in comparison with prior art systems.

A system very closely resembling a fixed connection could even be used, where a suitably formed counter part for the handle 5 would be fixed on the x-ray tube housing 4 or any accessory attached thereto. Such a counter part may be designed not actually locking the assembly but simply just serving as a counter surface or other structure for the contact surface 51 or the like of the handle 5. One possibility would be to have e.g. three short pins on the handle 5 adapted to align with and be received in corresponding apertures or recesses on the surface of the collimator 41 or of that of the aiming ring 10. Therefore, the handle 5 would not be fixed, and would be releasable. Such a system would make possible such a use of an assembly according to the invention closely resembling the intended way of use of the fixed assemblies according to the prior art, i.e. where the desired sensor 9—holder 8—bite-block 7—aiming arm 6—handle 5—assembly is first put together, after which a counter part or another counter structure of the handle 5, being fitted into or being an integral part of e.g. the aiming ring 10 attached to the collimator 41, is just brought into contact with the handle 5 to ensure the correct position and orientation of the x-ray beam.

The illustrated preferred embodiments of the invention presented above include a non-detachable connection between a sensor holder 8 and a bite-block 7. In view of the main inventive concept of the invention, however, it is not relevant whether this connection, or the one between the sensor holder 8 and the bite-block 7, is detachable or not. In fact, in this respect it is not relevant even whether or not the assembly includes a bite-block 7 at all, i.e. the aiming arm 6 may also be attachable directly to the sensor holder 8.

In order to facilitate the assembly of and use of, the assembly, as discussed above, the dimensions and forms of the parts of it may be designed such that when one wishes to position the sensor horizontally or vertically inside the mouth, the handle 5 may be provided with two connecting means 54, 55 for the aiming arm 6 with corresponding sensor orientation indicia 52, 53, whereby the sensor 9 will become automatically positioned in the desired orientation and in the center of the beam, for both left and right side imaging. The connecting means 54, 55 may permanently connect, or connect such that the handle 5 may be released and move and be adjusted. Assembly constructions according to such a principle can be designed for all the intra oral imaging modes, the Figs. of this specification showing only a anterior one. To this end, an aiming ring 10 having connection or contact means for the handle 5 may be designed such that it can be attached to the collimator in several orientations and released.

What is claimed is:

1. A positioning and aiming assembly for use with an x-ray source, comprising:
at least one aiming arm 6 connectable to a holder 8 for image data receiving means 9; and
at least one handle 5, 5′, said handle 5, 5′ including means for connecting it to said at least one aiming arm 6.

2. An aiming assembly according to claim 1, wherein said assembly is a part of a system including an intra oral x-ray device which is to be positioned with respect to an intra oral image data receiving means 9, which x-ray device 1 includes an x-ray source being placed in a housing 4, said housing 4 preferably including or having means whereto an elongated x-ray collimator 41 and/or some other accessories may be attached, the said at least one aiming arm 6 being connectable to the said handle 5 at, or at the proximity of its first end, and to a holder 8 for the said image data receiving means 9, either directly or via a bite-block 7, at its second end.

3. An aiming assembly according to claim 2, wherein the said at least one handle 5, 5′ is connected to the aiming arm 6 via means 54, 55 by which it may be released or moved along the aiming arm 6.

4. An aiming assembly according to claim 3, wherein the assembly includes means by which the said x-ray source may be brought repeatedly into at least one constant distance position and/or into known distance positions from the said image data receiving means.

5. An aiming assembly according to claim 4, which includes means whereby the said at least handle 5, 5′ may be connected to at least one fixed position on the aiming arm 6 and/or means whereby the said at least one handle 5, 5′ may be moved along the aiming arm 6, which includes indicia, such as a scale, showing the position of a handle 5 attached to it.

6. An aiming assembly according to claim 4, wherein there are arranged handle position indicia on the x-ray tube housing 4 or on an accessory, such as a collimator 41, attached thereto.

7. An assembly according to claim 4, wherein the x-ray tube housing 4, or any of the parts fixed to it, includes at least one connector or contact element for the said at least one handle 5, 5′.

8. An assembly according to claim 7, wherein the said connector or contact element is an integral part of an aiming ring 10 connectable to an elongated collimator 41, in turn connectable to the said x-ray tube housing 4.

9. An assembly according to claim 8, wherein the said aiming ring 10 is made connectable to the said collimator 41 in various orientations for supporting various imaging modes.

10. An assembly according to claim 9, wherein the said at least one handle 5, 5′ includes two connection means 54, 55 for the said at least one aiming arm 6, intended for horizontal and vertical orientations of the image data receiving means, correspondingly.

11. An assembly according to claim 9, wherein the said at least one handle 5, 5′ is provided with indicia 52, 53 of which of the said connection means 54, 55 is designed for horizontal and which for vertical orientation of the image data receiving means 9.

12. A positioning and aiming assembly for use with an x-ray source, comprising
an intra oral x-ray device which is to be positioned with respect to an intra oral image data receiving means,
which x-ray device 1 includes an x-ray source being placed in a housing 4, said housing 4 preferably including or having means whereto an elongated x-ray collimator 41 and/or some other accessories may be attached,
at least one aiming arm 6 connectable to a holder 8 for image data receiving means 9; and
at least one handle 5, 5′, said handle 5, 5′ including means for connecting it to said at least one aiming arm 6, and
a construction which is able to create at least two contact points, at least one contact line and/or at least one contact surface with a surface of the x-ray source housing 4, with that of the collimator 41 and/or with any other part attached to the x-ray source.

13. An assembly according to claim 12, wherein the said contact construction of a handle 5, 5′ includes a curved surface 51 with a curvature equal to that of a surface of the x-ray source housing, or a collimator or any other part attached thereto.

14. An assembly according to claim 13, wherein the said curved surface 51 is such that when brought into contact with its intended counter surface, they form an area of an elongated rectangle in direction perpendicular to that of the x-ray beam produced by the said x-ray source.

15. An assembly according to claim 14, wherein the said contact construction of a handle 5, 5′ includes at least two pins or the like, and the x-ray source housing, or a part attached thereto, corresponding wholes or recesses.

16. An assembly according to claim 15, wherein the said contact construction creates a three-point connection between at least one handle 5, 5′ and the x-ray source housing, or a part attached thereto.

17. An assembly according to claim 16, wherein there are attached two handles 5 to the aiming arm 6, at or at the proximity of the said second end of it.

18. An aiming assembly according to claim 12, wherein the said at least one handle 5, 5′ is connected to the aiming arm 6 via means 54, 55 by which it is not fixed and may be moved along the aiming arm 6.

19. An aiming assembly according to claim 18, wherein the said connection means 54, 55 include at least one hollow-through in the handle 5, 5′ with appropriate dimension with respect to that of the aiming arm 6.

20. An aiming assembly according to claim 12, wherein the assembly includes means by which the said x-ray source may be brought repeatedly into at least one constant distance position and/or into known distance positions from the said image data receiving means.

21. An assembly according to claim 20, wherein the x-ray tube housing 4, or any of the parts fixed to it, includes at least one connector or contact element for the said at least one handle 5, 5′.

22. An assembly according to claim 21, wherein the said connector or contact element is an integral part of an aiming ring 10 connectable to an elongated collimator 41, in turn connectable to the said x-ray tube housing 4.

23. An assembly according to claim 22, wherein the said aiming ring 10 is made connectable to the said collimator 41 in various orientations for supporting various imaging modes.

24. An assembly according to claim 12, wherein the said at least one handle 5, 5′ includes two connection means 54, 55 for the said at least one aiming arm 6, intended for horizontal and vertical orientations of the image data receiving means, respectfully.

25. An assembly according to claim 12, wherein the said at least one handle 5, 5′ is provided with indicia 52, 53 of which of the said connection means is designed for horizontal and which for vertical orientation of the image data receiving means 9.

26. A method for positioning and aiming an x-ray source with respect to a position of an intra oral image data receiving means, where the image data receiving means is attached to an aiming arm used as an aid in aiming the x-ray beam to the image data receiving means, wherein the aiming arm is further equipped with at least one handle, which handle is used as a gripping part in maneuvering the aiming arm—sensor holder assembly and as a fixed or an adjustable reference element with respect to the distance from it to the image data receiving means.

27. A method according to claim 26, wherein the said at least one handle attached to the said aiming arm and is used to achieve a desired x-ray source—image data receiving means distance by using the said at least one handle as a reference point in positioning the x-ray source for exposure.

28. A method according to claim 27, wherein the position of the said at least handle on the aiming arm is not fixed and adjusted by arranging a connection between the two such that the handle may be slid along the aiming arm.

29. A method according to claim 28, wherein the x-ray tube is positioned with respect to the said at least one handle by visually using a reference point on the x-ray source housing or any part attached thereto, especially by bringing a contact or connection structure being part of the x-ray source housing or any part attached thereto into contact with the said at least one handle.

30. A method for positioning and aiming an x-ray source with respect to a position of an intra oral image data receiving means, where the image data receiving means is attached to an aiming arm used as an aid in aiming the x-ray beam to the image data receiving means, wherein the aiming arm is further equipped with a handle, which handle is used as a gripping part in maneuvering the aiming arm—sensor holder—assembly and as an aligning tool for aiming the x-ray beam produced by the x-ray source.

31. A method according to claim 30, wherein the x-ray beam is aligned by bringing the x-ray source into contact with a contact construction arranged in the said handle, which is able to create at least two contact points, at least one contact line and/or at least one contact surface with a surface of the x-ray source housing, with that of the collimator and/or with any other part attached to the x-ray source.

32. A method according to claim 30, wherein for the first a desired positioning and aiming assembly containing a desired image data receiving means—sensor holder—aiming arm—assembly, possibly also including a desired bite-block, is put together, after which the image data receiving means is placed in a desired position inside patient's mouth and the x-ray beam aligned and orientated by making the said contact between the said handle and its counter surface or element while keeping the sensor stationary.

33. A method according to claim 30, wherein two handles are arranged on the aiming arm.

34. A method according to claim 30, wherein the contact between the handle and the x-ray device is releasable.

35. A method according to claim 30, wherein the contact is made between the handle and the outer surface of the collimator of the x-ray source or between the handle and an aiming ring of the x-ray source.
